(19) United States
(12) Patent Application Publication
(10) Pub. No.: US 2024/0340633 A1
(43) Pub. Date: Oct. 10, 2024

(54) SUBSCRIBER IDENTITY MODULE APPLICATION-BASED NETWORK REGISTRATION FAILURE RESOLUTION

(71) Applicants: AT&T Intellectual Property I, L.P., Atlanta, GA (US); AT&T Mobility II LLC, Atlanta, GA (US)

(72) Inventors: Inderpreet Ahluwalia, Austin, TX (US); Russell Vegh, Atlanta, GA (US); Kevin Ibrahim, Redmond, WA (US)

(21) Appl. No.: 18/298,301

(22) Filed: Apr. 10, 2023

(51) Int. Cl. H04W 8/20; H04W 8/02; H04W 76/18

(52) U.S. Cl. CPC H04W 8/20; H04W 8/02; H04W 76/18

(57) ABSTRACT

An application provided by a subscriber identity module of a cellular endpoint device may obtain a notification of a network rejection from a first cellular network and may select at least one update to at least one operational parameter of the subscriber identity module, in response to the notification of the network rejection, where the selecting is according to a selection logic of the application. The application provided by the subscriber identity module may then apply the at least one update to the at least one operational parameter of the subscriber identity module, in accordance with the selecting, and may generate a refresh instruction to the subscriber identity module.

The present disclosure relates generally to cellular networks, and more particularly to methods, non-transitory computer-readable media, and apparatuses for an application provided by a subscriber identity module of a cellular endpoint device to apply at least one update selected in accordance with a selection logic to at least one operational parameter of the subscriber identity module in response to a notification of a network rejection. The present disclosure also relates to methods, non-transitory computer-readable media, and apparatuses for transmitting an update to a selection logic of a subscriber identity module-based application of a cellular endpoint device for selecting updates to operational parameters of the subscriber identity module. The present disclosure further relates to methods, non-transitory computer-readable media, and apparatuses for an application of a processing system of a cellular endpoint device to apply at least one update selected in accordance with a selection logic to at least one operational parameter of a subscriber identity module in response to a notification of a network rejection.

### BACKGROUND

Roaming partner network issues may cause roaming cellular devices to be stuck in a non-registered, or non-attached state and unable to transmit or receive data. In addition, there may be significant turn-around time to troubleshoot and resolve roaming issues. For instance, a home mobile network operator may first need to identify that there is an issue and may then engage the roaming partner to investigate. Ultimately, without a view into network performance of the roaming partner network, the mobile network operator may have an incomplete view of the situation, which may prove challenging in resolving the issue for the subscribers of the mobile network operator.

### SUMMARY

In one example, the present disclosure discloses a method, computer-readable medium, and apparatus for an application provided by a subscriber identity module of a cellular endpoint device to apply at least one update selected in accordance with a selection logic to at least one operational parameter of the subscriber identity module in response to a notification of a network rejection. For example, an application provided by a subscriber identity module of a cellular endpoint device may obtain a notification of a network rejection from a first cellular network and may select at least one update to at least one operational parameter of the subscriber identity module, in response to the notification of the network rejection, where the selecting is according to a selection logic of the application. The application provided by the subscriber identity module may then apply the at least one update to the at least one operational parameter of the subscriber identity module, in accordance with the selecting, and may generate a refresh instruction to the subscriber identity module.

In one example, the present disclosure also discloses a method, computer-readable medium, and apparatus for transmitting an update to a selection logic of a subscriber identity module-based application of a cellular endpoint device for selecting updates to operational parameters of the subscriber identity module. For example, a processing system including at least one processor deployed in a first cellular network may obtain, from a SIM-based application of a cellular endpoint device, a notification of a network rejection by a second cellular network. The processing system may next select an update to a selection logic of a subscriber identity module-based application of the cellular endpoint device, where the selection logic is for selecting updates to operational parameters of a subscriber identity module of the cellular endpoint device. The processing system may then transmit, to the subscriber identity module, the update to the selection logic.

In one example, the present disclosure further discloses a method, computer-readable medium, and apparatus for an application of a processing system of a cellular endpoint device to apply at least one update selected in accordance with a selection logic to at least one operational parameter of a subscriber identity module in response to a notification of a network rejection. For example, an application operating on a processing system of a cellular endpoint device may obtain a notification of a network rejection from a first cellular network and may select at least one update to at least one operational parameter of a subscriber identity module of the cellular endpoint device, in response to the notification of the network rejection, where the selecting is according to a selection logic of the application. The application provided by the subscriber identity module may then apply the at least one update to the at least one operational parameter of the subscriber identity module, in accordance with the selecting, and may generate a refresh instruction to the subscriber identity module.

### BRIEF DESCRIPTION OF THE DRAWINGS

The teachings of the present disclosure can be readily understood by considering the following detailed description in conjunction with the accompanying drawings, in which:

FIG. 1 illustrates a block diagram of an example system, in accordance with the present disclosure;

FIG. 2 illustrates a flowchart of an example method for an application provided by a subscriber identity module of a cellular endpoint device to apply at least one update selected in accordance with a selection logic to at least one operational parameter of the subscriber identity module in response to a notification of a network rejection;

FIG. 3 illustrates a flowchart of an example method for transmitting an update to a selection logic of a subscriber identity module-based application of a cellular endpoint device for selecting updates to operational parameters of the subscriber identity module;

FIG. 4 illustrates a flowchart of an example method for an application of a processing system of a cellular endpoint device to apply at least one update selected in accordance with a selection logic to at least one operational parameter of a subscriber identity module in response to a notification of a network rejection; and

FIG. 5 illustrates a high level block diagram of a computing device specifically programmed to perform the steps, functions, blocks and/or operations described herein.

To facilitate understanding, similar reference numerals have been used, where possible, to designate elements that are common to the figures.

### DETAILED DESCRIPTION

The present disclosure broadly discloses methods, non-transitory computer-readable media, and apparatuses for an application provided by a subscriber identity module of a cellular endpoint device to apply at least one update selected in accordance with a selection logic to at least one operational parameter of the subscriber identity module in response to a notification of a network rejection, methods, non-transitory computer-readable media, and apparatuses for transmitting an update to a selection logic of a subscriber identity module-based application of a cellular endpoint device for selecting updates to operational parameters of the subscriber identity module, and methods, non-transitory computer-readable media, and apparatuses for an application of a processing system of a cellular endpoint device to apply at least one update selected in accordance with a selection logic to at least one operational parameter of a subscriber identity module in response to a notification of a network rejection. In particular, examples of the present disclosure describe a subscriber identity module (SIM)-based application (or “SIM applet”), which may be referred herein as an outage resolver SIM applet, that may automatically direct a cellular endpoint device to find another mobile network and/or a different radio access technology (RAT) when a registration rejection is received with respect to a particular network registration attempt (e.g., when roaming away from a home network).

In one example, the SIM application may include a second complementary SIM applet that may provide functionality for quality of service (QOS) reporting. For instance, a second QoS applet or the outage resolver SIM applet itself may gather and report on network performance indicators (e.g., “key performance indicators” (KPIs)) and may further gather and report environment factors (e.g., location, orientation, elevation, temperature, etc.), and/or device factors (e.g., orientation, location, battery level, transmit power, and so forth) to back-end systems so that the home mobile network operator (MNO) can use this data for support and troubleshooting, to provide insights to subscribers, and to meet contractual obligations. For instance, recorded and reported data may include: location Information, tracking area code (TAC)/cell identifier (ID), mobile country code (MCC), etc., access technology, rejection and extended rejection cause codes, network latency, power level (e.g. dBm), received signal strength indicator (RSSI), channel quality information (CQI), reference signal received power (RSRP), reference signal received quality (RSRQ), and so forth. In accordance with the present disclosure the SIM-based application may automatically direct the cellular endpoint device to find another network/RAT while roaming when a rejection is received. It should be noted that as referred to herein, a “network rejection” may include a location update rejection, an attach rejection, a routing area update (RAU) and/or tracking area update (TAU) rejection, an initial registration rejection, or the like. In one example, the two applets may each work in a standalone mode. However, in one example, QoS reporting applet's back-end data processing can be used to update the outage resolver SIM applet's functionality (e.g., a “network-controlled” mode) to make more intelligent roaming decisions.

Notably, roaming partner network issues may occasionally cause roaming cellular devices to be stuck in a non-registered, or non-attached state and unable to transmit or receive data. In addition, there may be significant turn-around time to troubleshoot and resolve such roaming issues. For instance a home MNO may first need to identify that there is an issue, and may then engage the roaming partner to investigate such issue. This may result in a significant delay in resolving the issue promptly, thereby negatively impacting a subscriber's experience. In addition, roaming partners may be reluctant or unwilling to provide data that may be useful in resolving roaming issues. In contrast, examples of the present disclosure augment network data of the home MNO and fill various gaps in collected data while subscribers are roaming on a partner network. In one example, data reported and gathered by cellular endpoint devices can be collected and stored by the home MNO. This may enable the home MNO to provide summaries related to particular events and/or aggregate statistics, e.g., hourly reports, daily reports, etc. that may identify: RAT type, network attach failures/rejects, RSRP/RSRQ, network error codes, network latency, and other factors in roaming scenarios. By utilizing data collected from the cellular endpoint devices via SIM-based applets, examples of the present disclosure may resolve potential network outages as they occur in real-time. In addition, this may eliminate/reduce the reliance on a customer calling into customer care and/or roaming assistance centers after the fact, or after a period of no/limited service. Streaming roaming network QoS data back to the home MNO in accordance with the present disclosure may provide a significant advantage in troubleshooting roaming issues as compared to prior methodologies as outlined above.

In one example, a network outage resolver application may be pre-loaded on a SIM or may be downloaded via an over-the-air (OTA) update, e.g., in response to a subscriber notification to the home MNO of an intention to travel where roaming is likely or inevitable, in response to a notification to the home MNO of a registration of a cellular endpoint device with a roaming network, or based on other determinations by the home MNO. It should be noted that as referred to herein a subscriber identity module (SIM) may include a SIM card (e.g., a universal integrated circuit card (UICC)), an eSIM (embedded SIM), an iSIM (integrated SIM), an iUICC (integrated UICC), or the like (e.g., in either a consumer device or an Internet of Things device, etc.) that may store an international mobile subscriber identity (IMSI) number, one or more authentication keys for authenticating the SIM to a cellular/mobile network, etc. For instance, a SIM may be any module that may store an integrated circuit card identifier (ICCID), a subscriber identifier (e.g., an international mobile subscriber identity (IMSI)), a telephone number (e.g., a mobile station international subscriber directory number (MSISDN)), etc., authentication key(s), user services (e.g., value-added services), local network information, personal identification number (PIN), unblocking code, and so forth. In addition, it should be noted that as referred to herein a “roaming network” may include any cellular network other than a SIM/cellular endpoint device's home cellular network/MNO. For instance, this may also include “home equivalent” networks that are distinct from the actual home cellular network/MNO.

In one example, the SIM-based application may use 3rd Generation Partnership Project (3GPP) SIM Application Toolkit (STK) commands to subscribe to events and to use the event data to determine if the cellular endpoint device should be moved from a rejecting roaming network/RAT to a different roaming network/RAT. In an autonomous mode the SIM-based application may react to the current conditions by itself, and may cause the cellular endpoint device to dynamically connect to a different network and/or RAT. Alternatively, or in addition, in a network-controlled mode, the SIM-based application may have selection logic updated by the home MNO (e.g., via an RSS, or the like). As such, the SIM-based application may be caused to direct the cellular endpoint device to connect to a different network and/or RAT using home MNO-defined selection logic that may be updated from time to time.

To further illustrate, in one example, the SIM-based application may update/change an operator-controlled public land mobile network (OPLMN) table/file (or OPLMNwACT (OPLMN with access technology)), a user-controlled public land mobile network (UPLMN) table/file, an equivalent HPLMN (home PLMN) table/file, a last registered public land mobile network (LRPLMN) record/file, a forbidden public land mobile network (FPMLN) table/file, or the like. More generally, the SIM-based application may update at least one operational parameter of the SIM to cause a change in a network registration attempt sequence as compared to the network registration attempt sequence without the at least one update. The update/change may be an addition, a deletion, a change in order/position in a list, etc. Similarly, in one example, the SIM-based application may change a higher Priority PLMN search period (HPPLMN) and/or may make a change to a location information (LOCI) record/file. In one example, the SIM-based application may alternatively or additional include logic to enable/disable certain RATs, e.g., enabling disabling and/or changing priority/preference among 5G and 4G/LTE, a non-cellular access technology (e.g., IEEE 802.11 or the like), and so forth. It should also be noted that as referred to herein, an “operational parameter” of a SIM may comprise an alterable SIM parameter (e.g., excluding physical dimensions of the SIM and/or other non-modifiable characteristics).

In one example, a same SIM-based network resolver application or a complementary QoS reporting application may similarly use 3GPP STK commands to subscribe to events and to report the events to the home MNO. In accordance with the present disclosure, the events may be related to events occurring in connection with the usage of roaming networks and/or attempts to register with one or more roaming networks. In one example, the SIM-based application may report data to the home MNO according to a schedule, or in response to threshold of data collection (e.g., when there is a threshold quantity of data to report), etc. Alternatively, or in addition, the SIM-based application may report data to the home MNO upon request from the home MNO. It should be noted that the SIM-based application may collect data relating to failed registration attempts or other network rejections, but may report such data (e.g., along with other recorded event data) when the cellular endpoint device is registered with the home MNO and/or a roaming partner network, when the cellular endpoint device can establish a data connection with one or more relevant entities for data collection within the home MNO, a cloud-based platform associated with the home MNO, or the like. For instance, the SIM-based application may use the crypto-processor on UICC-based cards to communicate with the home MNO infrastructure (e.g., transmitting encrypted data via HTTPS or the like). In one example, a dedicated/default access point name (APN) may be used for the cellular endpoint device to report event data or other performance data to the home MNO (e.g., network performance indicators/KPIs, environment factors and/or device factors, or the like).

As noted above, in one example, the home MNO may aggregate event data and other network performance data for one or more other networks, and for a given cellular endpoint device and/or for a plurality of cellular endpoint devices. In one example, the home MNO may generate and/or update selection logic for roaming scenarios, and may deploy the selection logic (e.g., an update to the selection logic and/or a new/replacement selection logic) to a given cellular endpoint device and/or to a plurality of cellular endpoint devices. In one example, the selection logic may be used to select at least one update to at least one operational parameter of the SIM of a given cellular endpoint device in response to the notification of a network rejection (e.g., from a roaming network) and further in response to one or more performance metrics of one or more cellular networks (e.g., performance metrics associated with the same roaming network and/or one or more other roaming networks).

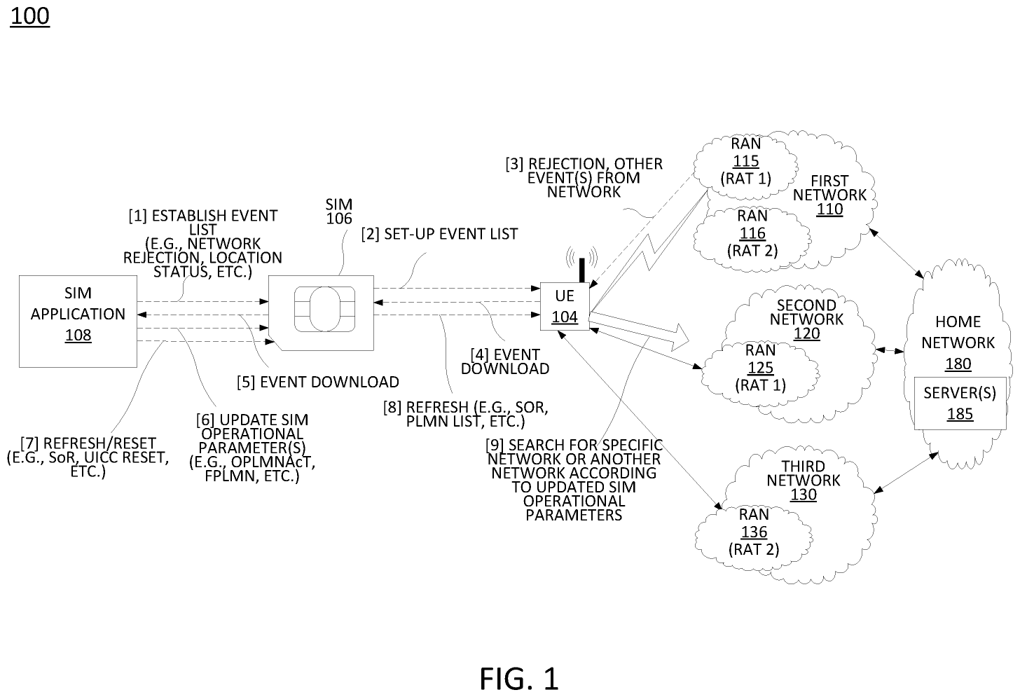

The other roaming networks may be cellular networks that may have been detected by the cellular endpoint device within a recent period of time, e.g., within the past week, past day, past hour, past one minute, etc., cellular networks most recently detected by the cellular endpoint device (e.g., the last 5 detected networks, the last 10 detected networks, etc.), cellular networks to which the cellular endpoint device has successfully attached/registered and/or attempted to register (e.g. the last 5 detected networks, the last 10 detected networks, etc. and/or those to which the cellular endpoint device has attached and/or registered within the last week, the last 24 hours, etc.). In one example, the selection logic may be location-based/location-specific. For instance, the selection logic may cause the SIM-based application to change one or more operational parameters of the SIM in response to one or more performance metrics collected by the cellular endpoint device, e.g., performance metrics that may be geographically relevant. For instance, if the cellular endpoint device is roaming in a foreign country, e.g., France, the performance metrics from the cellular endpoint device's home network in the United States may be irrelevant. In one example, the collecting and the transmitting of performance metrics to the home MNO can be via a QoS reporting application that may communicate with an outage resolver SIM application and the home MNO, where the home MNO may then download selection logic updates to the outage resolver SIM application. However, it should again be noted that in one example, the functionalities of the two applications may be part of the same application. It should also be noted that files/parameters in the SIM may be directly updated using Remote File Management (RFM), e.g., for SIMs that do not include an outage resolver SIM application. These and other aspects of the present disclosure are discussed in greater detail below in connection with the examples of FIGS. 1-5.

FIG. 1 illustrates an example system 100 in which examples of the present disclosure may operate. In one example, the system 100 includes a plurality of networks, e.g., cellular networks. For instance, as illustrated in FIG. 1, the system 100 may include a first network 110, a second network 120, a third network 130, and a home network 180 (e.g., a “fourth” network). It should be noted that although four networks are illustrated in the example of FIG. 1, other, further, and different examples may include more or less networks. For example, a mobile network operator (MNO), e.g., of home network 180 may have dozens of roaming network partners both international and domestic. Each of the networks may comprise a cellular network (e.g., a 5G network, a 4G/Long Term Evolution (LTE)/5G hybrid network, or the like). Thus, for example, first network 110 may include two radio access network (RAN) portions, e.g., RAN 115, which may use a first type of radio access technology (RAT) (e.g., RAT 1, which may comprise a 4G/LTE RAT), and RAN 116 which may use a second type of radio access technology (e.g., RAT 2, which may comprise a 5G RAT). It should be noted that although not illustrated in FIG. 1, home network 180 may similarly include one or more RANs utilizing one or more types of radio access technology. In this regard, it should also be noted that each of the RANs illustrated in FIG. 1 may include one or more cell sites comprising base station equipment, e.g., eNodeBs. gNodeBs, remote ratio heads (RRHs), baseband units, etc.

In one example, one or more of the radio access networks may each comprise a cloud RAN. For instance, a cloud RAN is part of the 3GPP 5G specifications for mobile networks. Each of the networks may include a 5G core network, or a 4G/LTE core network (e.g., an Evolved Packet Core (EPC)). However, as part of the migration of cellular networks towards 5G, a cloud RAN may be coupled to an EPC network until new cellular core networks are deployed in accordance with 5G specifications. Although the first network 110 is illustrated as including different RANs 115 and 116 (e.g., both 4G and 5G components), in another example, 4G and 5G components may be considered to be part of a single RAN. Thus, in one example, the first network 110 may comprise a cellular network with a “non-stand alone” (NSA) mode architecture where 5G radio access network components, such as a “new radio” (NR), “gNodeB” (or “gNB”), and so forth are supported by a 4G/LTE core network (e.g., an EPC network) which may be referred to as a hybrid, or integrated 4G/LTE-5G cellular core network, or a 5G “standalone” (SA) mode point-to-point or service-based architecture where components and functions of an EPC network are replaced by a 5G core network (e.g., an “NC”). For instance, in non-standalone (NSA) mode architecture, LTE radio equipment may continue to be used for cell signaling and management communications, while user data may rely upon a 5G new radio (NR), including millimeter wave communications, for example. It should also be noted that each of the networks illustrated in FIG. 1 may include multiple physical or logical radio access networks of a same RAT type. For example, first network 110 may include multiple network slices (e.g., logically distinct RANs) each using RAT 2.

In one example, each of the networks illustrated in FIG. 1 may provide various functions that support wireless services in a cellular environment. For instance, each of the networks may include an Internet Protocol (IP) packet core network that supports both real-time and non-real-time service delivery, e.g., as specified by the 3GPP standards. Thus for example, the various networks illustrated in FIG. 1 may include various network devices such as Mobility Management Entity (MME) and Serving Gateway (SGW), a Home Subscriber Server (HSS), a packet data network (PDN) gateway (PGW), which serves as a gateway that provides access between a cellular core network and various packet data networks (PDNs), others of the peer network(s) of FIG. 1, or the Internet in general, and the like. In accordance with the present disclosure, one or more of the networks may alternatively or additionally include other types of wireless network components e.g., 5G network components, 3G network components, etc. For example, as mentioned above, the first network 110 may comprise an integrated network, e.g., including any two or more of 2G-5G infrastructures and technologies (or any infrastructures and technologies to be deployed in the future such as 6G), and the like. For instance, the first network 110 may further comprise 5G components, including: an access and mobility management function (AMF), a network slice selection function (NSSF), a session management function (SMF), a unified data management function (UDM), a user plane function (UPF), and so forth.

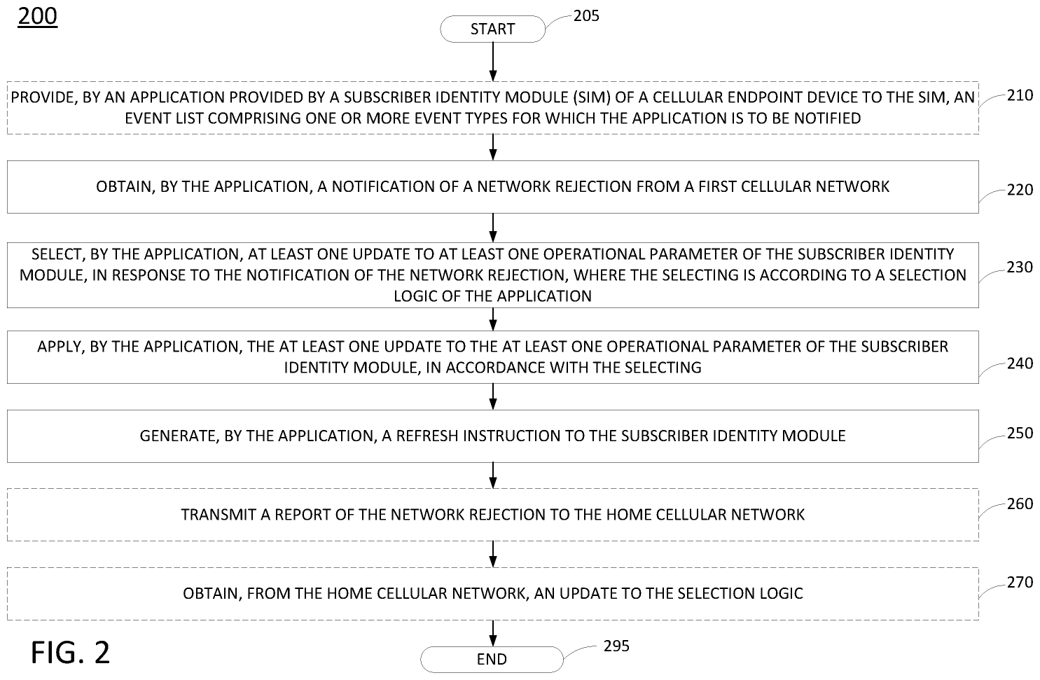

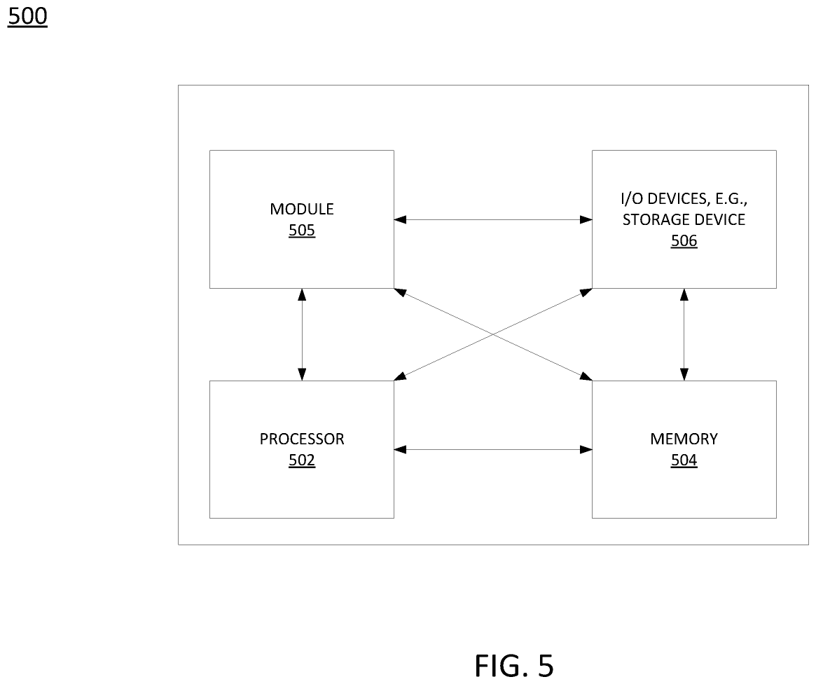

The system 100 provides an illustrative environment in which examples of the present disclosure may operate. To further illustrate, a cellular endpoint device, e.g., user equipment (UE) 104, may be associated with home network 180. For instance, UE 104 may be a device of a subscriber of a cellular service with home network 180. UE 104 may comprise a cellular telephone, a smartphone, a tablet computing device, a laptop computer, a pair of computing glasses, a wireless enabled wristwatch, a wireless transceiver for a fixed wireless broadband (FWB) deployment, or any other cellular-capable mobile telephony and computing devices (broadly, “a cellular endpoint device”). The UE 104 may further include a SIM 106. The SIM 106 may be a SIM card (e.g., a universal integrated circuit card (UICC)), or an eSIM that may store an ICCID, IMSI number, one or more authentication keys for authenticating the SIM to a cellular/mobile network, MSISDN, user services (e.g., value-added services), local network information, personal identification number (PIN), unblocking code, and so forth. In accordance with the present disclosure, SIM 106 may specifically store and implement the operations of a SIM application 108. In particular, a SIM 106 may include a small processor and memory that enables the SIM to host a lightweight operating system and to store and to run applications (applets). As such, the SIM 106 may comprise all or a portion of a computing system, such as computing system 500 depicted in FIG. 5, and may be configured to perform steps, functions, and/or operations for an application provided by a subscriber identity module of a cellular endpoint device to apply at least one update selected in accordance with a selection logic to at least one operational parameter of the subscriber identity module in response to a notification of a network rejection, e.g., in accordance with the example method 200 of FIG. 2 and/or as described elsewhere herein.

It should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 5 and discussed below) or multiple computing devices collectively configured to perform various steps, functions, and/or operations in accordance with the present disclosure. In accordance with the present disclosure, a processing system may specifically comprise a SIM.

In an illustrative example, in stage [1] (as labeled in FIG. 1), the SIM application 108 may be configured to establish an event list via the SIM 106. For example, the SIM application 108 may utilize one or more STK commands to subscribe to event notifications from the SIM 106. More specifically, the SIM application 108 may request to be notified of occurrences of events of one or more event types. These may include network rejection events, location status events, device status events (e.g., battery level, transmit power, power cycle events, etc.), and so forth. In stage [2], the SIM 106, in accordance with the one or more commands, may communicate with one or more other components of the UE 104 to set-up the event list, e.g., to subscribe to event notifications from the one or more other components of the UE 104, e.g., a central processor of UE 104. In one example, stage [2] may also utilize STK commands, or the like. Accordingly, the UE 104 may monitor for and collect device and/or network performance data, including events of the event type(s) requested by the SIM application 108 and SIM 106.

At stage [3] the UE 104 may detect an event of one of the event type(s), e.g., a network rejection from the first network 110. The network rejection may include a location update rejection, an attach rejection, a RAU/TAU rejection, an initial registration rejection, or the like. The rejection may be obtained via a base station from an AMF of first network 110. For instance, the AMF may reject the registration based upon input from an authentication server function (AUSF), a network slice selection function (NSSF), and so forth. For example, roaming UEs may not be permitted on a particular cell service group (CSG) and/or in a particular tracking area (TA) of the first network 110 (but may be permitted on others). Alternatively, or in addition, a base station may reject the registration based on insufficient resources, based upon an incomplete or malformed registration request (e.g., an incorrect PLMN identifier), based upon the UE 104 (and/or one or more identifiers of the UE 104 and/or SIM 106) being on a blocking/reject list, and so forth.

At stage [4], the UE 104 may download a notification of the event to the SIM 106 (e.g., via STK response). Similarly, at stage [5] the SIM 106 may forward a notification of the event to the SIM application 108 (e.g., in response to the obtaining of the notification from the UE 104 at the previous stage [4]). In one example, the notification at stage [5] may likewise comprise an STK response. In one example, the event information contained in the notifications of stages [4] and

may include rejection and extended rejection cause codes.

In response to the notification of the event (e.g., a network rejection from the first network 110), the SIM application 108 may apply a selection logic to determine whether and when to update one or more operational parameters of the SIM 106. For instance, an input to the selection logic may include the present rejection event. One or more additional inputs may further include information for other events relating to the same network (e.g., first network 110) or one or more other networks (e.g., second network 120 and/or third network 130, etc.), other performance indicators (or “performance metrics”) relating to the same or one or more other networks, e.g., TAC/cell ID, MCC, etc., access technology, network latency, dBm, RSSI, CQI, RSRP, RSRQ, and so forth, and/or one or more device performance indicators, such as battery level, power cycle events, processor utilization, memory utilization, application usage information, and so forth. In one example, selection logic may be location-specific. Accordingly, in one example, an input to the selection logic may further include location information of the UE 104. For instance, if the UE 104 is located in foreign country 1, e.g., France, the relevant roaming network partners may be entirely different from the relevant roaming network partners in foreign country 2, e.g., Japan. In addition, the considerations of which roaming network partners and which radio access technologies are to have priority may be different for different locales. This may be based upon the capabilities of the other networks (e.g., 5G coverage versus 4G/LTE), rates to be charged and/or reciprocal subscriber roaming arrangements, and so forth. Other considerations may include past, current, and/or predicted performance of one or more roaming partner networks (which may also be location specific), where such considerations may be built into the selection logic that is deployed to the SIM application 108.

The selection logic may be configured to cause the SIM application 108 to select one or more updates to one or more SIM operational parameters. For instance, the SIM application 108 may select to update an OPLMN table/file. For instance, the update may comprise an addition, a deletion, a change in order/position in a list, etc. To illustrate, the first network 110 may be first in the OPLMN table, the second network 120 may be second in the OPLMN table, and the third network 130 may be third in the OPLMN table. However, the third network 130 may be moved to the second position in the list. Alternatively, or in addition, the first network 110 may be moved to the second position or the third position in the list. In another example, the SIM 106 may be configured to automatically move the first network 110 off of the OPLMN list/table and place the first network 110 in a forbidden public land mobile network (FPMLN) table/file, or the like. However, the selection logic may identify that the first network 110 should be strongly preferred for roaming subscriber connections, e.g., in a particular locale. As such, the selection logic of SIM application 108 may be configured to remove the first network 110 from the FPMLN table. Alternatively, or in addition, the first network 110 may be placed back into the first position in an OPLMN table (if it had been previously removed by the SIM 106) in a future time or at another location.

It should be noted that for illustrative purposes, the three networks may be referred to as being first, second, and third in a list. However, it should be understood that in some examples, these positions may merely be relative to one another. In other words, there may be other networks that are in higher or lower positions in a longer list, or in intermediate positions between the positions of the first network 110, the second network 120, and/or the third network 130. Thus, for illustrative purposes “first,” “second,” and “third” positions should be understood as being relative to one another, but do not exclude the possibility of other preceding, following, or intermediate positions in such a list.

In still another example, the SIM application 108 may detect an excessive battery drain on the UE 104, which may be correlated/associated with numerous failed registration attempts with the first network 110. For instance, the performance data may be obtained from event notifications subscribed to by the SIM application 108 (e.g., including registration failure notifications as well as at least one device performance indicator (e.g., battery level updates)). The SIM application 108 may then select to remove the first network 110 from the OPLMN table and/or from a user-controlled public land mobile network (UPLMN) table/file, may alternatively or additionally select to place the first network 110 in an FPLMN table/file, or the like. Similarly, the SIM application 108 may alternatively or additionally shorten a higher Priority PLMN search period (HPPLMN). Thus, for example, the number of attempts to connect to a higher priority PLMN (e.g., first network 110) may be reduced before moving on to attempting to connect to a next highest priority PLMN (e.g., in a UPLMN and/or OPLMN list), such as second network 120.

It should again be noted that in one example, the SIM application 108 may alternatively or additionally include logic to enable/disable certain RATs, e.g., enabling disabling and/or changing priority/preference among 5G and 4G/LTE, a non-cellular access technology (e.g., IEEE 802.11 or the like), and so forth. Thus, for example, SIM application 108 may select to update an OPLMNwACT (OPLMN with access technology) table/file or the like, e.g., to indicate a higher priority to RAT 2 versus RAT 1. For example, FIG. 1 illustrates that first network 110 includes RAN 115 and RAN 116 with different radio access technologies. Thus, the SIM application 108 may update the OPLMNwACT to reprioritize RAT 2 over RAT 1. In one example, first network 110 may retain its priority within the list. In another example, the selection logic may cause the SIM application 108 to reprioritize such that the third network 130 is first/higher in the list. For example, the home network 180 may establish the selection logic for SIM application 108 to generally prefer 5G RAT when available. In addition, in a location where home network 180 does not provide service, but where first network 110, second network 120, and third network 130 may be available, the first network 110 may be generally preferred for 5G service, whereas when 5G may be unavailable or unreliable and usage of 4G/LTE may be more appropriate, then the third network 130 may be the preferred roaming partner.

The foregoing are merely a few examples of the types of updates to SIM operational parameters that may be selected by SIM application 108 in accordance with a selection logic. In addition, the foregoing describes merely a few trigger conditions that may cause the selection logic to select to implement one or more SIM operational parameter updates. Thus, it is should be appreciated that various other types of updates may be selected in response to various other conditions via a selection logic in accordance with the present disclosure. At stage [6] the SIM application 108 may update the one or more operational parameters of the SIM 106 in accordance with the selection logic (e.g., such as according to any one of the examples described above, or others). Notably, the changes to operational parameters of SIM 106 may not immediately affect the operation of UE 104. For instance, UE 104 may need to re-load/re-read the SIM operational parameters in order to update operations accordingly. As such, stage [7] may include the SIM application 108 issuing a refresh/reset command to the SIM 106. For instance, the command may be a UICC reset command, a steering of roaming (SoR) refresh, or the like.

At stage [8] the SIM 106 may self-implement a refresh/reset (e.g., via an interrupt to one or more other components of UE 104). Accordingly, UE 104 may reload/re-read the SIM 106 and thus may read and load the one or more updated operational parameters. As such, at stage [9] the UE 104 may attempt to register with one or more other networks (e.g., second network 120 and/or third network 130) via one or more RANs with one or more types of RATs, e.g., according to the priorities of an UPLMN list, an OPLMN list, a FPLMN list, etc. as defined in the SIM operational parameters.

It should be noted that the foregoing description of the use of the system 100 is provided as an illustrative example only. Thus, other, further, and different examples may include additional functions, may omit functions, and/or may include different functions. For instance, preceding stage [1], the SIM application 108 itself, or an update to the selection logic and/or new selection logic may be downloaded and installed to the SIM 106. For example, the home network 180 may collect performance indicators of one or more roaming network partners (e.g., first network 110, second network 120, third network 130, etc.). As noted above, the performance indicators may include network performance indicators, device factors/device performance indicators, environment factors, etc. In one example, the performance indicators may be collected by user equipment (e.g., cellular endpoint devices) as the devices are roaming and as the devices may utilize services of various cellular networks and/or attempt to register with various cellular networks. In one example, the performance indicators may be collected by SIM-based applications (e.g., SIM application 108 and/or a different companion application). In one example, the SIM-based applications of various UEs may report data to the home network 180 according to a schedule, in response to a threshold of data collection (e.g., when there is a threshold quantity of data to report by a particular UE), etc. Alternatively, or in addition, the SIM-based applications may report data to the home network 180 upon request from the home MNO. It should be noted that the SIM-based applications may collect data relating to failed registration attempts, but may report such data (e.g., along with other recorded event data) when each respective UEs is registered with the home network 180 and/or a roaming partner network, and when each respective UE can establish a data connection with one or more relevant entities for data collection within the home network 180, a cloud-based platform associated with the home network 180, or the like. For instance, each SIM-based application may use the crypto-processor on UICC-based cards to communicate with server(s) 185 (e.g., transmitting encrypted data via HTTPS or the like).

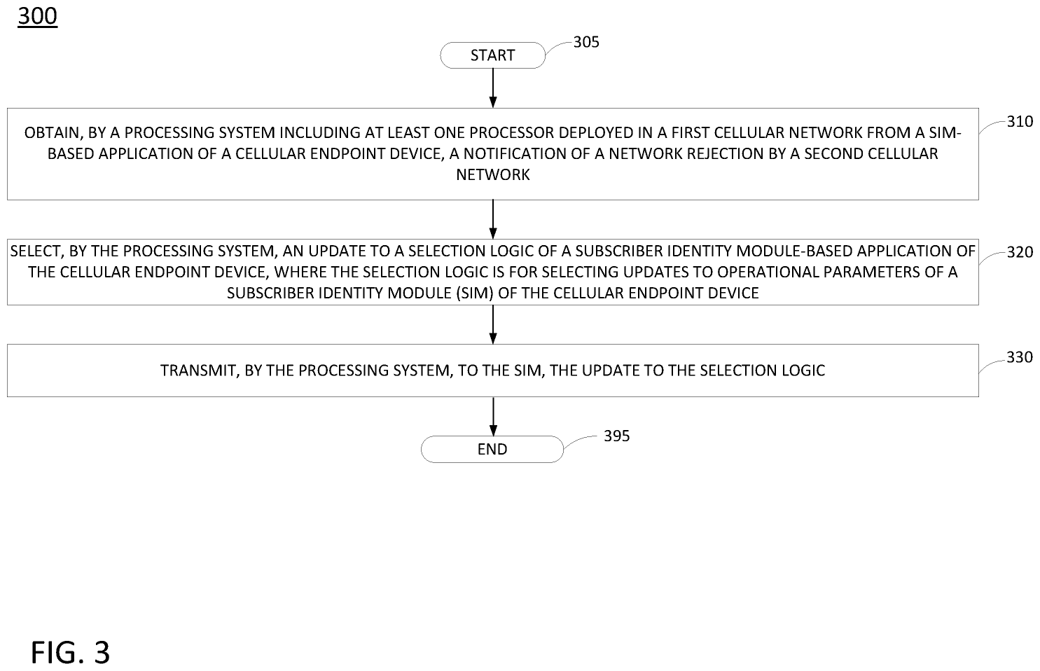

Notably, the server(s) 185 may aggregate event data and other network performance indicator data for one or more roaming networks, and for a given UE and/or for a plurality of UEs. In one example, the server(s) 185 may generate and/or update selection logic for roaming scenarios, and may deploy the selection logic (e.g., an update to the selection logic and/or a new/replacement selection logic) to a given UE (e.g., UE 104) and/or to a plurality of UEs. In one example, server(s) 185 may each comprise all or a portion of a computing system, such as computing system 500 depicted in FIG. 5, and may be configured to perform steps, functions, and/or operations for transmitting an update to a selection logic of a subscriber identity module-based application of a cellular endpoint device for selecting updates to operational parameters of the subscriber identity module, e.g., in accordance with the example method 300 of FIG. 3 and/or as described elsewhere herein. In one example, server(s) 185 may be referred to as a roaming selection server of the home network 108. In one example, the selection logic may be to select the at least one update to at least one operational parameter of the SIM of a given UE in response to one or more performance metrics of one or more cellular networks (e.g., including prior network rejections for the same or one or more other UEs). In this regard, it should be noted that in one example, stage [9] may be followed by completing a registration with a roaming network (e.g., first network 110, second network 120, third network 130, etc.) and uploading performance indicators/performance metrics to server(s) 185 of home network 180. In addition, this may be followed by downloading of new/updated selection logic to SIM application 108 (e.g., in response to new network rejection information that is analyzed by server(s) 185 and/or other performance indicators). It should be noted that the new/updated selection logic may not require an immediate update to the

SIM operational parameters. Rather, the selection logic may analyze new event information (e.g., per stage [5]), which may or may not result in an update to one or more SIM operational parameters (e.g., per stage [6]) at that time. Likewise, additional events may be notified to the SIM application 108, any one or more of which may result in a selection of a change to one or more SIM operational parameters (or not). In other words, if the selection logic does not detect a condition, or conditions, that call for making changes to the operational parameter(s) of the SIM 106, then it will allow current, normal operations to continue, e.g., try to connect to networks on the list(s) in the order listed, to allow for the selection of either 5G or 4G/LTE, etc. For instance, the UE 104 may simply go down the list of UPLMN, OPLMNACT, etc. by default. However, in accordance with the present disclosure, the SIM application 108 may change the lists according to the selection logic in response to certain conditions that may be detected.

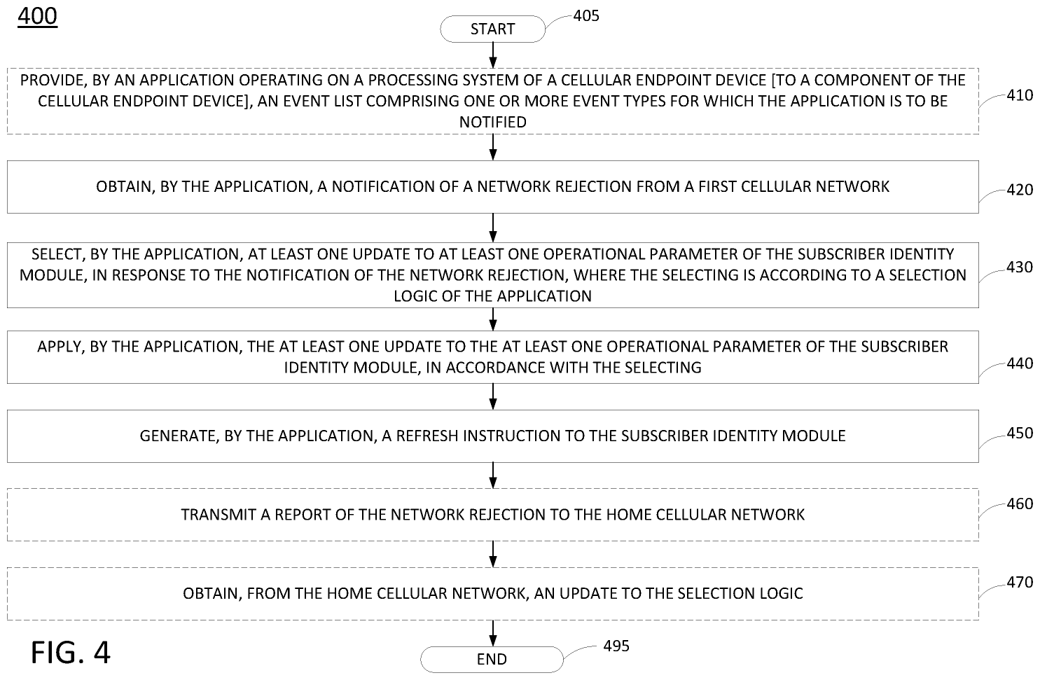

In one example, operations described above with respect to SIM application 108 may alternatively or additionally be performed by an application of the UE 104 (e.g., a non-SIM application). For instance, a background application may be in operation on UE 104 that is configured with selection logic such as described above in connection with SIM application 108. However, the non-SIM application may subscribe to events, e.g., from an event bus of the UE 104 and may determine whether and when to make updates to one or more operational parameters of the SIM 106. In one example, the application may communicate with the SIM 106 using a hashed value of a security key from the home network 180. The SIM 106 may therefore only respond to commands from the application when authorized by the home network 180. In one example, the application may cause the SIM to update one or more operational parameters. In one example, the application may further cause the SIM 106 to initiate a refresh/reset (e.g., using STK commands or the like). In this regard, UE 104 may comprise all or a portion of a computing system, such as computing system 500 depicted in FIG. 5, and may be configured to perform steps, functions, and/or operations for an application of a processing system of a cellular endpoint device to apply at least one update selected in accordance with a selection logic to at least one operational parameter of a subscriber identity module in response to a notification of a network rejection, e.g., in accordance with the example method 400 of FIG. 4 and/or as described elsewhere herein.

It is again noted that the example of system 100 is merely illustrative of one network configuration that is suitable for implementing examples of the present disclosure. As such, other logical and/or physical arrangements for the system 100 may be implemented in accordance with the present disclosure. For example, the system 100 may be expanded to include additional networks, such as network operations center (NOC) networks, additional access networks, and so forth. The system 100 may also be expanded to include additional network elements such as border elements, routers, switches, policy servers, security devices, gateways, a content distribution network (CDN) and the like, without altering the scope of the present disclosure. In addition, system 100 may be altered to omit various elements, substitute elements for devices that perform the same or similar functions, combine elements that are illustrated as separate devices, and/or implement network elements as functions that are spread across several devices that operate collectively as the respective network elements. Thus, these and other modifications are all contemplated within the scope of the present disclosure.

In addition, it should be noted that although examples herein describe cellular endpoint devices having subscriber identity modules, in other, further and different embodiments, examples of the present disclosure may implement one or more other components or devices providing the same or substantially similar functions as a subscriber identity module. For instance, examples of the present disclosure may employ any integrated circuit or other devices that may perform typical SIM card related functions (e.g., storage of an international mobile subscriber identity (IMSI) number, storage of an authentication key for authenticating the SIM to a mobile network, etc.) and that is at least capable of performing the functions mentioned herein which are described as being performed by a SIM card. Accordingly, the term SIM is intended to refer to any or all of such circuits or devices.

FIG. 2 illustrates a flowchart of an example method 200 for an application provided by a subscriber identity module of a cellular endpoint device to apply at least one update selected in accordance with a selection logic to at least one operational parameter of the subscriber identity module in response to a notification of a network rejection, in accordance with the present disclosure. In one example, steps, functions and/or operations of the method 200 may be performed by a device as illustrated in FIG. 1, e.g., SIM 106 implementing a SIM-based application (e.g., SIM application 108), or any one or more components thereof, such as a processing system (e.g., having an operating system and at least one application installed and in operation thereon) or collectively via a plurality devices in FIG. 1, such as SIM 106 in conjunction with UE 104 (e.g., one or more other components thereof, such as processor, a cellular modem, etc.), and so forth. In one example, the steps, functions, or operations of method 200 may be performed by a computing device or system 500, and/or a processing system 502 as described in connection with FIG. 5 below. Similarly, in one example, the steps, functions, or operations of method 200 may be performed by a processing system comprising one or more computing devices collectively configured to perform various steps, functions, and/or operations of the method 200. For instance, multiple instances of the computing device or processing system 500 may collectively function as a processing system. For illustrative purposes, the method 200 is described in greater detail below in connection with an example performed by a processing system, such as processing system 502. The method 200 begins in step 205 and may proceed to optional step 210 or to step 220.

At optional step 210, an application provided by a subscriber identity module (SIM) of a cellular endpoint device may provide, to the SIM, an event list comprising one or more event types for which the application is to be notified. It should be noted that the SIM-based application may communicate with a primary SIM application and/or OS to provide the event list. As noted above, the one or more event types may include a network rejection event type and may further include a location status event type, measurements/alarms/performance metrics of various performance metric types, and so forth (e.g., TAC/cell ID, MCC, etc., access technology, rejection and extended rejection cause codes, network latency, dBm, RSSI, CQI, RSRP, RSRQ, and so forth). As also noted above, the SIM may be configured to request notification of events of the one or more event types from another component of the cellular endpoint device, e.g., a cellular modem, a processor providing an event bus, etc. In one example, optional step 210 may comprise a communication using one or more STK commands.

At step 220, the SIM-based application may obtain a notification of a network rejection from a first cellular network. For instance, step 220 may comprise operations that are the same or similar to stage [5] as illustrated in FIG. 1 and discussed above. In one example, the notification of the network rejection may indicate at least one type of rejection. For instance, the at least one type of rejection may comprise at least one of: a location update rejection, an attach rejection, a RAU/TAU rejection, or an initial registration rejection. In one example, the SIM-based application may further obtain notifications of a plurality of events and/or obtain various network and/or device performance indicators, environment factors, etc. For example, events may be forwarded to the SIM-based application based upon the event types in the event list that may be provided at optional step 210. In one example, the notification may be in accordance with a 3GPP STK or the like. It should be noted that the first cellular network is distinct from a home network of the cellular endpoint device/SIM. Thus, the cellular endpoint device/SIM may be in a roaming scenario.

At step 230, the SIM-based application selects at least one update to at least one operational parameter of the SIM, in response to the notification of the network rejection, where the selecting is according to a selection logic of the SIM-based application. As described above, in one example, the selection logic may be provided by a home cellular network of the cellular endpoint device/SIM. For example, the selection logic may be based on a plurality of performance metrics of a plurality of cellular networks including the first cellular network. In addition, in one example, the plurality of performance metrics may be obtained from a plurality of SIM-based applications of a plurality of cellular endpoint devices. The plurality of performance metrics may be associated with the at least one type of rejection (e.g., a number or rate of location update (LU) rejections for a particular cellular network, cell, sector, and/or location, a number or rate of attach rejections for a particular cellular network, cell, sector, and/or location, etc.).

As further described above, the at least one update to the at least one operational parameter of the SIM may comprise at least one of: at least one change to a UPLMN table, at least one change to an OPLMN table (which in one example may comprise an OPLMNwACT), at least one change to a FPLMN table, at least one change to an EHPLMN table, at least one change to an LRPLMN table, a change to a HPPLMN search period setting, at least one change to a LOCI record, and so forth. In one example, the at least one update to the at least one operational parameter of the SIM may comprise a change to a priority of a type of radio access technology from a plurality of radio access technologies of the cellular endpoint device.

More generally, the at least one update to the at least one operational parameter of the SIM is to cause a change in a network registration attempt sequence as compared to the network registration attempt sequence without the at least one update. In one example, the at least one update may be to cause the cellular endpoint device to attempt to register with a second cellular network. For instance, the selection logic may be to cause the cellular endpoint device to choose at least a second cellular network for a subsequent network registration attempt (e.g., where the SIM, prior to the update would select to continue to register with the first cellular network on the next attempt). In another example, the selection logic may be to cause the cellular endpoint device to reattempt to register with the first cellular network, (e.g., where prior to the update, the cellular endpoint device would select another cellular network for the next attempt in accordance with the SIM operational parameters). As noted above, it may be the case that some SIMs/UEs are configured to place a network on a “do not attempt list” after a threshold number of failed attempts, but this could be overridden by placing the network back on an OPLMN list, removing the network from a FPLMN list, etc.

In one example, the selection logic may be configured to select the at least one update to the at least one operational parameter of the SIM in response to the notification of the network rejection and further in response to one or more performance metrics of one or more cellular networks (e.g., performance metric(s) of the same type(s) for which the selection logic may be configured by the home network prior to deployment to the SIM). The one or more cellular networks may include the first cellular network and/or at least a second cellular network. The one or more cellular networks may be cellular networks that may have been detected by the cellular endpoint device within a recent period of time, e.g., within the past week, past day, past hour, etc., cellular networks most recently detected by the cellular endpoint device (e.g., the last 5 cellular networks, the last 10 cellular networks, etc.), cellular networks to which the cellular endpoint device has successfully attached and/or attempted to attach (e.g. the last 5 cellular networks, the last 10 cellular networks, etc. and/or those to which the cellular endpoint device has attached within the last week, the last 24 hours, etc.), or the like. In one example, the various cellular networks may also include network slices and/or one or more virtual mobile network operators (VMNOs) to which the cellular endpoint device may attempt to register. For instance, some VMNOs may maintain cellular core network components while other utilize cellular networks' radio access infrastructure. As noted above, the selection may be location-based. For instance, the selection may be location-based using the one or more performance metrics (e.g., performance metrics that may be geographically relevant (e.g., if the cellular endpoint device is roaming in France, the performance metrics from the cellular endpoint device's home network in the United States may be irrelevant)).

At step 240, the SIM-based application applies the at least one update to the at least one operational parameter of the subscriber identity module, in accordance with the selecting. For instance, step 240 may include a communication from the SIM-based application to the SIM (e.g., a primary SIM application and/or SIM OS) via one or more STK commands.

At step 250, the SIM-based application generates a refresh instruction to the subscriber identity module. For instance, the refresh instruction may cause the SIM to issue a refresh command to the cellular endpoint device (e.g., to an operating system thereof). The refresh instruction may comprise a SoR refresh, a UICC reset, or the like. As such, the cellular endpoint device may reload/re-read the SIM and thus may read and load the one or more updated operational parameters. As such, the cellular endpoint device may attempt to register with one or more other networks via one or more RANs with one or more types of RATs, e.g., according to the priorities of an UPLMN list, an OPLMN list, a FPLMN list, etc. as defined in the SIM operational parameters, may attempt to re-register with the first network (where the UE, prior to the update, would select another cellular network for the next attempt in accordance with the previous SIM operational parameters), etc.

At optional step 260, the SIM-based application may transmit a report of the network rejection to the home cellular network. It should be noted that the report may be transmitted when the cellular endpoint device is eventually attached/registered with a cellular network (whether the first or a different cellular network). In one example, the report may include information on one or more other events and/or other performance indicators (e.g., which may be accumulated by the SIM-based application prior to an eventual successful registration/attachment). As noted above, the reporting may be periodic, may be opportunistic (e.g., when signal strength and/or throughput is high, when attached to a preferred roaming partner network, etc.), and/or may be made on-demand by request from the home cellular network.

At optional step 270, the SIM-based application may obtain, from the home cellular network, an update to the selection logic. For instance, the update may be transmitted in response to the report, e.g., as soon as practicable and/or otherwise close in time to the report. Alternatively, it may be transmitted at a later time in response to the report and further in response to various other reports/performance metrics from the same SIM-based application and/or from SIM-based applications of various other cellular endpoint devices engaging in similar recording and reporting. It should be noted that the update to the selection logic may alternatively or additionally be based upon information obtained via other channels. For instance, a roaming network partner may experience and outage, congestion, etc. in an area in which the roaming cellular endpoint device is located and may voluntarily share an alert with the home network. As such, while the roaming network partner may be a generally preferred partner (e.g., a high priority PLMN) the home network may adjust the selection logic to reduce a HPPLMN search period setting, e.g., if an initial registration fails when attempting to connect to the roaming partner network.

Following step 250, or one of optional steps 260 or 270, the method 200 may proceed to step 295 where the method 200 ends.

It should be noted that the method 200 may be expanded to include additional steps or may be modified to include additional operations or omit operations with respect to the steps outlined above. For example, the method 200 may be repeated through various cycles of obtaining new/updated selection logic, obtaining event notifications, selecting changes to SIM operational parameters, reporting to a home network, and so forth. In one example, the method 200 may further include installing and/or activating the update to the selection logic that may be obtained at optional step 270, applying the new selection logic with respect to one or more new event notifications, and so forth. In one example, the method 200 may be expanded or modified to include steps, functions, and/or operations, or other features described in connection with the example(s) of FIGS. 1, 3, and/or 4 or as described elsewhere herein. Thus, these and other modifications are all contemplated within the scope of the present disclosure.

FIG. 3 illustrates a flowchart of an example method 300 for transmitting an update to a selection logic of a subscriber identity module-based application of a cellular endpoint device for selecting updates to operational parameters of the subscriber identity module, in accordance with the present disclosure. In one example, steps, functions and/or operations of the method 300 may be performed by a device as illustrated in FIG. 1, e.g., server(s) 185, or any one or more components thereof, such as a processing system, or collectively via a plurality devices in FIG. 1, such as any one or more of server(s) 185 in conjunction with one another and/or in conjunction with one or more other devices, such as a UDR, an AUSF, and so forth. In one example, the steps, functions, or operations of method 300 may be performed by a computing device or system 500, and/or a processing system 502 as described in connection with FIG. 5 below. Similarly, in one example, the steps, functions, or operations of method 300 may be performed by a processing system comprising one or more computing devices collectively configured to perform various steps, functions, and/or operations of the method 300. For instance, multiple instances of the computing device or processing system 500 may collectively function as a processing system. For illustrative purposes, the method 300 is described in greater detail below in connection with an example performed by a processing system, such as processing system 502. The method 300 begins in step 305 and proceeds to step 310.

At step 310, the processing system (e.g., a processing system deployed in a first cellular network) may obtain, from a cellular endpoint device, a notification, or report, of a network rejection by a second cellular network. The notification may be obtained via the second cellular network or a third cellular network, e.g., where the cellular endpoint device is attached and/or registered to the second or third cellular network. The rejection can be of one of the types mentioned above, e.g., a location update rejection, an attach rejection, a RAU/TAU rejection, or an initial registration rejection. The first cellular network may be a home network of the cellular endpoint device/SIM, and the second cellular network, the third cellular network, etc. may be roaming networks.

At step 320, the processing system selects an update to a selection logic of a SIM-based application of the cellular endpoint device, where the selection logic is for selecting updates to operational parameters of a SIM of the cellular endpoint device. In one example, the update to the selection logic may be selected based on a plurality of performance metrics of a plurality of cellular networks including the second cellular network. For instance, the plurality of performance metrics may be obtained from a plurality of SIM-based applications of a plurality of cellular endpoint devices. As noted above, the update to the selection logic can be a change to the existing/prior selection logic, an addition or deletion to the existing/prior selection logic, and/or a new selection logic to replace the prior/existing selection logic. The operational parameters of the SIM may be alterable SIM parameters (e.g., excluding fixed physical properties of the SIM such as the dimensions, memory capacity, etc.).

In one example, the update may be selected in response to the notification/report, e.g., close in time to the notification, or may be transmitted at a later time in response to the notification and further in response to various other reports/performance metrics from the same SIM-based application and/or from SIM-based applications of various other cellular endpoint devices engaging in similar recording and reporting. It should be noted that the update to the selection logic may alternatively or additionally be based upon information obtained via other channels. For instance, a roaming network partner may experience an outage, congestion, etc. in an area in which the roaming cellular endpoint device is located and may voluntarily share an alert with the home network. As such, while the roaming network partner may be a generally preferred partner (e.g., a high priority PLMN), the home network may adjust the selection logic to reduce a HPPLMN search period setting, e.g., if an initial registration fails when attempting to connect to the roaming partner network.

At step 330, the processing system transmits, to the SIM (e.g., via to the cellular endpoint device), the update to the selection logic. The SIM, or the SIM-based application operating on the SIM may self-install and/or activate the update to the selection logic that may be obtained. The SIM-based application may then obtain new event notifications, apply the new selection logic with respect to one or more new event notifications, determine whether to make any changes to one or more SIM operational parameters based on the event notifications, and so forth.

Following step 330, the method 300 may proceed to step 395 where the method 300 ends.

It should be noted that the method 300 may be expanded to include additional steps or may be modified to include additional operations or omit operations with respect to the steps outlined above. For example, the method 300 may be repeated through various cycles of obtaining notifications of network rejections, selecting updates to the selection logic, and transmitting the updates to the SIM. In one example, the method 300 may include obtaining performance indicators from the same and/or other cellular endpoint devices relating to the first cellular network and/or one or more other cellular networks, where the selecting of the update at step 320 may be based upon the various collected performance indicators (e.g., including at least the notification of the network rejection received at step 310). In one example, step 310 may be preceded by downloading the SIM-based application to the SIM, e.g., with an initial selection logic, or downloading an initial selection logic to the SIM-based application. In one example, the method 300 may be expanded or modified to include steps, functions, and/or operations, or other features described in connection with the example(s) of FIGS. 1, 2, and/or 4, or as described elsewhere herein. Thus, these and other modifications are all contemplated within the scope of the present disclosure.

FIG. 4 illustrates a flowchart of an example method 400 for an application of a processing system of a cellular endpoint device to apply at least one update selected in accordance with a selection logic to at least one operational parameter of a subscriber identity module in response to a notification of a network rejection, in accordance with the present disclosure. In one example, steps, functions and/or operations of the method 400 may be performed by a device as illustrated in FIG. 1, e.g., UE 104, or any one or more components thereof, such as a processing system (e.g., having an operating system and at least one application installed and in operation thereon) or collectively via a plurality devices in FIG. 1, such as UE 104 in conjunction with server(s) 185, and so forth. In one example, the steps, functions, or operations of method 400 may be performed by a computing device or system 500, and/or a processing system 502 as described in connection with FIG. 5 below. Similarly, in one example, the steps, functions, or operations of method 400 may be performed by a processing system comprising one or more computing devices collectively configured to perform various steps, functions, and/or operations of the method 400. For instance, multiple instances of the computing device or processing system 500 may collectively function as a processing system. For illustrative purposes, the method 400 is described in greater detail below in connection with an example performed by a processing system, such as processing system 502. The method 400 begins in step 405 and may proceed to optional step 410 or to step 420.

At optional step 410, an application provided by a processing system including at least one processor of a cellular endpoint device may provide, to a component of the cellular endpoint device (e.g., to a SIM of the cellular endpoint device, to an operating system provided by one or more processors of the cellular endpoint device, or to another component of the cellular endpoint device, (e.g., a cellular modem, a processor providing an event bus, etc.)) an event list comprising one or more event types for which the application is to be alerted. As noted above, the one or more event types may include a network rejection event type and may further include a location status event type, measurements/alarms/performance metrics of various performance metric types, and so forth (e.g., TAC/cell ID, MCC, etc., access technology, rejection and extended rejection cause codes, network latency, dBm, RSSI, CQI, RSRP, RSRQ, and so forth).

At step 420, the application may obtain a notification of a network rejection from a first cellular network. For instance, step 420 may comprise operations that are the same or similar to stage [5] as illustrated in FIG. 1 and discussed above. In one example, step 420 may comprise operations that are the same or similar to step 220 of the example method 200 described above.

At step 430, the application selects at least one update to at least one operational parameter of the SIM, in response to the notification of the network rejection, where the selecting is according to a selection logic of the application. For instance, as described above, the selection logic may be provided by a home cellular network of the cellular endpoint device/SIM. For example, the selection logic may be based on a plurality of performance metrics of a plurality of cellular networks including the first cellular network. In addition, in one example, the plurality of performance metrics may be obtained from a plurality of SIM-based applications of a plurality of cellular endpoint devices. The plurality of performance metrics may be associated with the at least one type of rejection. In one example, step 430 may comprise operations that are the same or similar to step 230 of the example method 200 described above. For instance, as noted above, the at least one update to the at least one operational parameter of the SIM may be to cause a change in a network registration attempt sequence as compared to the network registration attempt sequence without the at least one update. In addition, in one example, the selection logic may be configured to select the at least one update to the at least one operational parameter of the SIM in response to the notification of the network rejection and further in response to one or more performance metrics of one or more cellular networks. In addition, as noted above, the selection logic may be location-dependent.

At step 440, the application applies the at least one update to the at least one operational parameter of the subscriber identity module, in accordance with the selecting. For instance, step 440 may include a communication from the application to the SIM (e.g., a primary SIM application and/or SIM OS) via one or more STK commands. In one example, step 440 may comprise operations that are the same or similar to step 240 of the example method 200 described above.

At step 450, the application generates a refresh instruction to the SIM. For instance, the refresh instruction may cause the SIM to issue a refresh command to the cellular endpoint device (e.g., to an operating system thereof). The refresh instruction may comprise a SoR refresh, a UICC reset, or the like. As such, the cellular endpoint device may reload/re-read the SIM and thus may read and load the one or more updated operational parameters. In one example, step 450 may comprise operations that are the same or similar to step 250 of the example method 200 described above.

At optional step 460, the application may transmit a report of the network rejection to the home cellular network. It should be noted that the report may be transmitted when the cellular endpoint device is eventually attached/registered with a cellular network (whether the first or a different cellular network). In one example, the report may include information on one or more other events and/or other performance indicators (e.g., that may be accumulated by the application prior to an eventual successful registration/attachment). As noted above, the reporting may be periodic, may be opportunistic (e.g., when signal strength and/or throughput is high, when attached to a preferred roaming partner network, etc.), and/or may be made on-demand by request from the home network. In one example, optional step 460 may comprise operations that are the same or similar to optional step 260 of the example method 200 described above.

At optional step 470, the application may obtain, from the home cellular network, an update to the selection logic. For instance, optional step 470 may comprise operations that are the same or similar to optional step 270 of the example method 200 described above.

Following step 450, or one of optional steps 460 or 470, the method 400 may proceed to step 495 where the method 400 ends.

It should be noted that the method 400 may be expanded to include additional steps or may be modified to include additional operations or omit operations with respect to the steps outlined above. For example, the method 400 may be repeated through various cycles of obtaining new/updated selection logic, obtaining event notifications, selecting changes to SIM operational parameters, reporting to a home network, and so forth. In one example, the method 400 may further include installing and/or activating the update to the selection logic that may be obtained at optional step 470, applying the new selection logic with respect to one or more new event notifications, and so forth. In one example, the method 400 may be expanded or modified to include steps, functions, and/or operations, or other features described in connection with the example(s) of FIGS. 1, 2, and/or 3 or as described elsewhere herein. Thus, these and other modifications are all contemplated within the scope of the present disclosure.

In addition, although not specifically specified, one or more steps, functions, or operations of the example methods 200-400 may include a storing, displaying, and/or outputting step as required for a particular application. In other words, any data, records, fields, and/or intermediate results discussed in the method(s) can be stored, displayed, and/or outputted either on the device executing the method or to another device, as required for a particular application. Furthermore, steps, blocks, functions or operations in FIGS. 2-4 that recite a determining operation or involve a decision do not necessarily require that both branches of the determining operation be practiced. In other words, one of the branches of the determining operation can be deemed as an optional step. Furthermore, steps, blocks, functions or operations of the above described method(s) can be combined, separated, and/or performed in a different order from that described above, without departing from the examples of the present disclosure.

FIG. 5 depicts a high-level block diagram of a computing device or processing system specifically programmed to perform the functions described herein. For example, any one or more components or devices illustrated in FIG. 1, or described in connection with the example methods 200-400 of FIGS. 2-4, respectively, may be implemented as the processing system 500. As depicted in FIG. 5, the processing system 500 comprises one or more hardware processor elements 502 (e.g., a microprocessor, a central processing unit (CPU) and the like), a memory 504, (e.g., random access memory (RAM), read only memory (ROM), a disk drive, an optical drive, a magnetic drive, a Universal Serial Bus (USB) drive, a SIM and/or UICC, or the like, and so forth), a module 505 for an application provided by a subscriber identity module of a cellular endpoint device to apply at least one update selected in accordance with a selection logic to at least one operational parameter of the subscriber identity module in response to a notification of a network rejection, for transmitting an update to a selection logic of a subscriber identity module-based application of a cellular endpoint device for selecting updates to operational parameters of the subscriber identity module, or for an application of a processing system of a cellular endpoint device to apply at least one update selected in accordance with a selection logic to at least one operational parameter of a subscriber identity module in response to a notification of a network rejection, and various input/output devices 506, e.g., a camera, a video camera, storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like). In accordance with the present disclosure input/output devices 506 may also include antenna elements, antenna arrays, remote radio heads (RRHs), baseband units (BBUs), transceivers, power units, and so forth.

Although only one processor element is shown, it should be noted that the computing device may employ a plurality of processor elements. Furthermore, although only one computing device is shown in the Figure, if the method(s) as discussed above is implemented in a distributed or parallel manner for a particular illustrative example, i.e., the steps of the above method(s) or the entire method(s) are implemented across multiple or parallel computing devices, e.g., a processing system, then the computing device of this Figure is intended to represent each of those multiple computers. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented. The hardware processor 502 can also be configured or programmed to cause other devices to perform one or more operations as discussed above. In other words, the hardware processor 502 may serve the function of a central controller directing other devices to perform the one or more operations as discussed above.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computing device, or any other hardware equivalents, e.g., computer readable instructions pertaining to the method(s) discussed above can be used to configure a hardware processor to perform the steps, functions and/or operations of the above disclosed method(s). In one example, instructions and data for the present module or process 505 for an application provided by a subscriber identity module of a cellular endpoint device to apply at least one update selected in accordance with a selection logic to at least one operational parameter of the subscriber identity module in response to a notification of a network rejection, for transmitting an update to a selection logic of a subscriber identity module-based application of a cellular endpoint device for selecting updates to operational parameters of the subscriber identity module, or for an application of a processing system of a cellular endpoint device to apply at least one update selected in accordance with a selection logic to at least one operational parameter of a subscriber identity module in response to a notification of a network rejection (e.g., a software program comprising computer-executable instructions) can be loaded into memory 504 and executed by hardware processor element 502 to implement the steps, functions or operations as discussed above in connection with the example methods 200-400. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 505 for an application provided by a subscriber identity module of a cellular endpoint device to apply at least one update selected in accordance with a selection logic to at least one operational parameter of the subscriber identity module in response to a notification of a network rejection, for transmitting an update to a selection logic of a subscriber identity module-based application of a cellular endpoint device for selecting updates to operational parameters of the subscriber identity module, or for an application of a processing system of a cellular endpoint device to apply at least one update selected in accordance with a selection logic to at least one operational parameter of a subscriber identity module in response to a notification of a network rejection (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. Furthermore, a “tangible” computer-readable storage device or medium comprises a physical device, a hardware device, or a device that is discernible by the touch. More specifically, the computer-readable storage device may comprise any physical devices that provide the ability to store information such as data and/or instructions to be accessed by a processor or a computing device such as a computer or an application server.

While various embodiments have been described above, it should be understood that they have been presented by way of example only, and not limitation. Thus, the breadth and scope of a preferred embodiment should not be limited by any of the above-described example embodiments, but should be defined only in accordance with the following claims and their equivalents.

What is claimed is:

1. A method comprising:
obtaining, by an application provided by a subscriber identity module of a cellular endpoint device, a notification of a network rejection from a first cellular network;
selecting, by the application, at least one update to at least one operational parameter of the subscriber identity module, in response to the notification of the network rejection, wherein the selecting is according to a selection logic of the application;
applying, by the application, the at least one update to the at least one operational parameter of the subscriber identity module, in accordance with the selecting; and
generating, by the application, a refresh instruction to the subscriber identity module.

2. The method of claim 1, further comprising:
providing, by the application to the subscriber identity module, an event list comprising one or more event types for which the application is to be notified.

3. The method of claim 2, wherein the one or more event types include a network rejection event type, wherein the network rejection from the first cellular network is of the network rejection event type.

4. The method of claim 2, wherein the one or more event types further include a location status event type.

5. The method of claim 2, wherein the subscriber identity module is configured to request notification of events of the one or more event types from a component of the cellular endpoint device.

6. The method of claim 5, wherein the component comprises a cellular modem.

7. The method of claim 1, wherein the refresh instruction causes the subscriber identity module to issue a refresh command to the cellular endpoint device.

8. The method of claim 1, wherein the refresh instruction comprises:
a steering of roaming refresh command; or
a universal integrated circuit card reset command.

9. The method of claim 1, wherein the notification of the network rejection includes at least one type of rejection, wherein the at least one type of rejection comprises at least one of:
a location update rejection;
an attach rejection;
a routing area update rejection;
a tracking area update rejection; or
an initial registration rejection.

10. The method of claim 1, wherein the at least one update to the at least one operational parameter of the subscriber identity module comprises at least one of:
at least one change to a user-controlled public land mobile network table;
at least one change to an operator-controlled public land mobile network table;
at least one change to a forbidden public land mobile network table;
at least one change to an equivalent home public land mobile network table;
at least one change to a last registered public land mobile network record;
a change to a higher priority public land mobile network search period setting; or
at least one change to a location information record.

11. The method of claim 1, wherein the at least one update to the at least one operational parameter of the subscriber identity module comprises a change to a priority of a type of radio access technology from a plurality of radio access technologies of the cellular endpoint device.

12. The method of claim 1, wherein the at least one update to the at least one operational parameter of the subscriber identity module is to cause a change in a network registration attempt sequence as compared to the network registration attempt sequence without the at least one update.

13. The method of claim 1, wherein the selection logic is provided by a home cellular network, wherein the selection logic is based on a plurality of performance metrics of a plurality of cellular networks including the first cellular network.

14. The method of claim 13, wherein the plurality of performance metrics is obtained from a plurality of subscriber identity module-based applications of a plurality of cellular endpoint devices.

15. The method of claim 1, further comprising:
transmitting a report of the network rejection to a home cellular network; and
obtaining, from the home cellular network, an update to the selection logic.

16. A method comprising:
obtaining, by a processing system including at least one processor deployed in a first cellular network from a subscriber identity module-based application of a cellular endpoint device, a notification of a network rejection by a second cellular network;
selecting, by the processing system, an update to a selection logic of the subscriber identity module-based application of the cellular endpoint device, wherein the selection logic is for selecting updates to operational parameters of a subscriber identity module of the cellular endpoint device; and
transmitting, by the processing system, to the subscriber identity module the update to the selection logic.

17. The method of claim 16, wherein the notification is obtained via:
the second cellular network; or
a third cellular network.

18. The method of claim 16, wherein the update to the selection logic is selected based on a plurality of performance metrics of a plurality of cellular networks including the second cellular network.

19. The method of claim 18, wherein the plurality of performance metrics is obtained from a plurality of subscriber identity module-based applications of a plurality of cellular endpoint devices.

20. A method comprising:
obtaining, by an application operating on a processing system of a cellular endpoint device, a notification of a network rejection from a first cellular network;
selecting, by the application, at least one update to at least one operational parameter of a subscriber identity module of the cellular endpoint device, in response to the notification of the network rejection, wherein the selecting is according to a selection logic of the application;
applying, by the application, the at least one update to the at least one operational parameter of the subscriber identity module, in accordance with the selecting; and
generating, by the application, a refresh instruction to the subscriber identity module.
